(19) United States
(12) Patent Application Publication
(10) Pub. No.: US 2023/0252802 A1
(43) Pub. Date: Aug. 10, 2023

(54) TECHNIQUE FOR IDENTIFYING A CONTAINER AND VERIFYING HUMAN-READABLE INFORMATION

(71) Applicant: Mark Edward Schaeffer, Santa Fe, NM (US)

(72) Inventor: Mark Edward Schaeffer, Santa Fe, NM (US)

(21) Appl. No.: 18/158,860

(22) Filed: Jan. 24, 2023

Related U.S. Application Data
(60) Provisional application No. 63/302,628, filed on Jan. 25, 2022.

(51) Int. Cl. G06V 20/62; G06K 7/14; G06V 30/146; G06V 10/82

(52) U.S. Cl. CPC G06V 20/62; G06K 7/1413; G06K 7/1417; G06V 10/82; G06V 30/146

(57) ABSTRACT

In certain embodiments, apparatus has a camera, a screen, and a processor that receives images of a container from the camera and generates displays rendered on the screen. The processor reads a machine-readable code, a lot number, and an expiration date in the container images; uses the code to retrieve corresponding lot number and expiration date stored in a database; determines whether (i) the retrieved lot number matches the read lot number and (ii) the retrieved expiration date matches the read expiration date; and indicates whether or not the information on the container has been successfully verified based on the determination. The processor can determine that the code, lot number, and expiration date are not all visible in a first image generated by the camera and indicate that the container and/or the camera needs to be repositioned to generate another image showing the information missing from the first image.

### CROSS-REFERENCE TO RELATED APPLICATIONS

This application claims the benefit of the filing date of U.S. provisional application no. 63/302,628, filed on 01/25/22 as attorney docket no. 1406.002PROV, the teachings of which are incorporated herein by reference in their entirety.

### BACKGROUND

### Field of the Disclosure

This disclosure relates to systems and methods for reading information on a package/container, such as a drug container, that is partially in machine-readable form and partially in human-readable form.

### Description of the Related Art

This section introduces aspects that may help facilitate a better understanding of the disclosure. Accordingly, the statements of this section are to be read in this light and are not to be understood as admissions about what is prior art or what is not prior art.

Supply-chain systems have utilized machine-readable codes on packages for more than 30 years. Every item in a grocery store has a machine-readable barcode that is used to identify the item. Almost every product that is sold or shipped is packaged in a container with a machine-readable barcode on the outside. All modern inventory systems can read the barcode on the container to identify the contents. Some regulated products also have a lot or batch number and expiration date assigned to and printed on the container. (Every regulated food and drug item in the United States is required to have lot number and expiration date.) Modern systems now incorporate the ability to read 2D barcodes, which can also contain the container expiration date and lot number in machine-readable form. This allows these inventory systems to not only track quantity, but also the lot number and expiration date. This assists in product recalls and managing inventory to ensure that items are sold before their expiration date.

However, while most large containers (having many small containers inside) have the lot number and expiration date encoded in machine-readable form on the packaging, many smaller containers do not. Some small containers, such as drug vials and cereal boxes, have a machine-readable code that identifies only the container, with the lot number and expiration date written on the package in human-readable form only. This makes lot number and expiration date tracking of the individual item a difficult and manual process prone to errors. An operator must scan the package with a barcode scanner, and then manually enter the lot number and expiration date into the system. When a drug is administered to a patient in a hospital, a system can scan the drug to automatically record its administration. But then the user must manually enter the lot number and verify that the drug is not expired.

US Pat. 8,009,913 B specifies a system that captures the lot number and expiration date from a unit dose package (e.g., a pill blister pack). The system reads the 1D barcode to obtain identifying information on the unit dose package. It then references a database to get location-specific information on where to read the lot number and expiration date from the unit dose package. The system uses OCR to read the lot number and expiration date from this location on the package. However, there is no error correction on the OCR results for the system to verify if the lot number and expiration date were read accurately.

US Pat. 6,336,696 B1 specifies a system that captures a barcode, and also uses OCR to read the same information contained in the barcode that is written below the barcode. The system can then match the output from the barcode decoding with the OCR results to ensure the barcode was scanned correctly. This system can be applied when the barcode on the package has been damaged, but the numbers below the barcode are still legible. However, the system cannot read the lot number or expiration date on the container.

Some barcode scanners can be configured to read human-readable information. However, the operator must put the barcode scanner in a special mode. The operator must then manually position the scanner over the information to be read. The operator must also manually verify the OCR was done correctly, because the barcode scanner has no error correction for the OCR results. It is still a manual process subject to human error.

### SUMMARY

This disclosure relates to systems and methods for reading information on a package/container that is partially in machine-readable form, and partially in human-readable form. The human-readable content is verified against known datasets linked to the machine-readable content to ensure it is read at an accuracy approaching the accuracy as reading all the same information in machine-readable form.

Provided are systems and methods for reading a machine-readable code from a container along with human-readable information that is printed on the container (e.g., an expiration date and lot number). The methods include reading a machine-readable code from the container, providing feedback to the operator or autonomous system to reposition the system / container (if needed), reading the human-readable information on the container using OCR (Optical Character Recognition), and verifying that the information from OCR is correct. The machine-readable code contains information that can be linked to a database that is used to identify the contents of the container. The machine-readable code can also be linked to a database of valid lot numbers with expiration dates for the contents. The systems perform methods to verify that the human-readable information matches a valid lot number and expiration date before confirming to the operator or autonomous system that the container has been fully identified and verified.

As used herein, the term “human-readable information” refers to information that is represented in forms such as strings of alphanumeric characters that can be directly read by humans, while the term “machine-readable information” refers to information that is represented in forms such as one-dimensional (1D) barcodes or two-dimensional (2D) barcodes, such as QR codes, that are typically converted into human-readable information by a machine.

This disclosure relates generally to devices that can scan a container for machine-readable codes and other specific information that is printed in human-readable form on the package, such as an expiration date and lot number. The disclosure describes methods of non-location-specific feedback to the operator or autonomous system to reposition the package and/or device to enable the systems to read the human-readable information after the machine-readable information is decoded. The disclosure also describes methods to ensure that the information that is in human-readable form is read accurately by the device by comparing the information to previously verified datasets linked to the container ID.

One such implementation is a system and methods for accurately reading the information contained on a drug container in the United States. All drug containers in the U.S. have a Food and Drug Administration (FDA) National Drug Code (NDC) number encoded into a 1D barcode. They also have a human-readable expiration date and a human-readable lot number printed on the drug container. The system uses visual feedback to the operator to reposition the drug container after the 1D barcode is read so that the lot number and expiration date can be read from the drug container. After the system verifies that the expiration date and lot number have been accurately read from the drug container using OCR, visual feedback is given to the operator indicating that all the information on the drug container has been fully identified and verified by the system.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIGS. 1A and 1B are perspective views of a scanning system for drug containers that provides visual feedback to the user according to an embodiment of the disclosure;

FIG. 1C is a block diagram of the scanning system of FIGS. 1A and 1B;

FIG. 2 is a perspective view of the camera and holder of the scanning system of FIGS. 1A and 1B with a cylindrical drug container;

FIG. 3 is a perspective view of the camera and holder of the scanning system of FIGS. 1A and 1B with a rectangular drug container;

FIG. 4 is a state diagram of an algorithm implemented by the scanning system of FIGS. 1A and 1B to scan a container that contains a machine-readable code (barcode) and has human-readable information (lot number and expiration date);

FIG. 5 is a screenshot generated by the scanning system of FIGS. 1A and 1B informing the user that the system is ready to scan a drug container;

FIG. 6 is a screenshot generated by the scanning system of FIGS. 1A and 1B showing the camera view with a detected object;

FIG. 7 is a screenshot generated by the scanning system of FIGS. 1A and 1B informing the user of a successful scan;

FIG. 8 is a screenshot generated by the scanning system of FIGS. 1A and 1B informing the user that the barcode has been successfully decoded, and the system is now trying to read the lot number and expiration date;

FIG. 9 is a screenshot generated by the scanning system of FIGS. 1A and 1B informing the user that it is trying to read the lot number and expiration date, and the number of times it has tried;

FIG. 10 is a screenshot generated by the scanning system of FIGS. 1A and 1B informing the user that it has scanned a drug container that is expired;

FIG. 11 is a screenshot generated by the scanning system of FIGS. 1A and 1B informing the user that it has scanned a drug container that has been recalled by the FDA;

FIG. 12 is a screenshot generated by the scanning system of FIGS. 1A and 1B informing the user that it has scanned a drug container that has an extended expiration date;

FIG. 13 is a screenshot generated by the scanning system of FIGS. 1A and 1B informing the user that it has scanned a drug container that has an extended expiration date, but the drug container is still expired;

FIG. 14 is a screenshot generated by the scanning system of FIGS. 1A and 1B informing the user that it was unable to read the lot number and expiration date from the drug container;

FIG. 15 is a flow diagram of an algorithm implemented by the scanning system of FIGS. 1A and 1B to extract the expiration date and lot number from the text output of an OCR engine;

FIG. 16 is a flow diagram of an algorithm implemented by the scanning system of FIGS. 1A and 1B to verify the expiration date and lot number that have been extracted from the text output of an OCR engine;

FIG. 17 is a perspective view of a labeling system for drug containers that incorporates the scanning system of FIGS. 1A and 1B;

FIG. 17A is a block diagram of the labeling system of FIG. 17;

FIG. 18 is a screenshot a graphical user interface generated by the labeling system of FIG. 17 used to capture the initials of the user;

FIG. 19 shows a label created and printed by the labeling system of FIG. 17;

FIG. 20 is a photograph of several different types and sizes of drug containers; and

FIG. 21 is a schematic block diagram of the LOT/EXP Database for the scanning system of FIGS. 1A and 1B used to store lot number and expiration date pairs that can be used to verify OCR results.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

In the United States, the FDA regulates drugs. They approve all drugs that are allowed to be administered to patients. Drug manufacturers are required to provide the FDA with a current list of all drugs manufactured, prepared, propagated, compounded, or processed for sale in the U.S. at their facilities. Drugs are identified and reported using a unique, three-segment number called the National Drug Code (NDC) which serves as the FDA’s identifier for drugs. The FDA publishes the listed NDC numbers in the NDC Directory which is updated daily.

The NDC Directory contains product-listing data submitted for all finished drugs including prescription and over-the-counter drugs, approved and unapproved drugs, and repackaged and relabeled drugs.

The FDA requires drug containers to be labeled with a 1D barcode that contains the NDC number, a human-readable expiration date, and a human-readable lot number. Optionally, the container may also have a 2D barcode that contains the NDC number, expiration date, and lot number. However, many drug containers do not have a 2D barcode - and so the expiration date and lot number cannot be captured by a computer system with a barcode scanner.

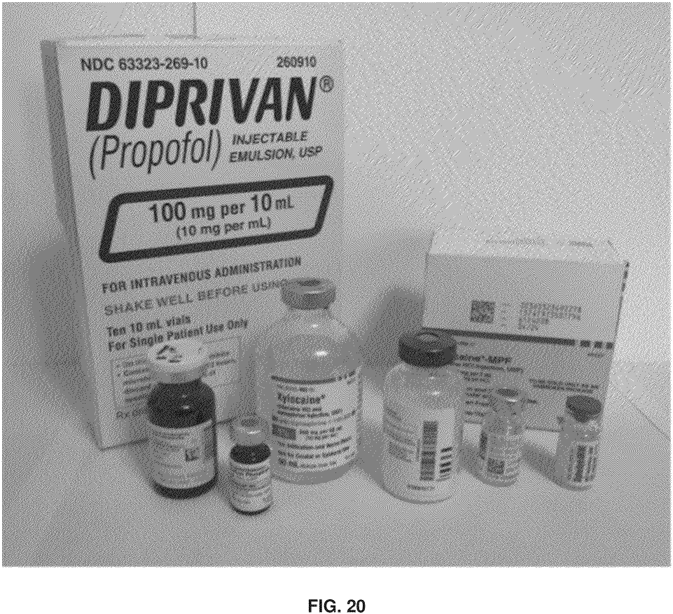

There are many shapes and sizes of drug containers (see, e.g., FIG. 20). Some drugs come in boxes. Others are contained in small round vials. While other drugs are packaged in ampoules or bottles. The NDC number is always encoded into a 1D barcode on an individual drug container. Numerous systems in hospitals and health clinics across the U.S. have barcode scanners that can read these barcodes to identify drugs before they are administered to patients. Medical facilities use barcode scanners to scan drugs to take inventory. Some of the individual drug containers (less than 20%) also have a 2D barcode on them. This 2D barcode is encoded with the NDC number, the expiration date, and the lot number. The 2D barcode allows these systems equipped with a barcode scanner to check for expired drugs and record lot numbers of drugs administered to patients. This information is particularly useful to have in these automated systems. However, since most drug containers have the lot number and expiration date printed on the drug container only in human-readable form, the lot number and expiration date must be manually entered into these systems. The barcode scanners cannot read the human-readable lot number or expiration date from the drug container. As used herein, unless explicitly stated otherwise, the terms “lot number” and “expiration date” are assumed to refer to human-readable representations of that information as opposed to machine-readable representations.

Embodiments of this disclosure replace a conventional barcode scanner with a system that scans a drug container to get the NDC number from the barcode and then accurately reads the lot number and expiration date that is printed on the drug container. The system requires no verification by the operator that the lot number and expiration date have been read correctly.

There are many challenges to overcome to achieve this:
There is no standard on where the barcode is on the drug container. It could be anywhere on the container.
There is no standard on where the lot number and expiration date are written on the drug container. They may be written close to the barcode, or they may be written on the other side of the drug container.
In many situations, the NDC number from a barcode and the lot number and expiration date cannot be captured in a single image. The drug container and/or the camera must be repositioned to see one or the other.
There is no standard font used to write the lot number and expiration date. Therefore with some fonts, the number 0 and the letter O look almost identical. It is important to get all digits correct when recording the lot number.
There is no standard format to write the expiration date on the drug container. The expiration date can be written in any one of more than 10 different formats on the drug container.
The lot number and expiration date may be written left to right on the drug container, or they may be written from bottom to top. The system detects the orientation of the text for the OCR engine to function correctly.
Many drug containers are cylindrical. When an image is taken of writing on a cylindrical container, the writing is curved on a 2D image. Many conventional OCR engines have difficulty decoding this text.
The lighting in the room can introduce shadows in the image of the drug container that are removed before sending the image to a conventional OCR engine.
Sometimes the writing on the drug container is black on white. But occasionally reverse writing is used on a drug container, where the lot number and expiration date are written in white on a black background. The system detects this and reverses the writing in the image before sending the image to a conventional OCR engine.
Some of the drug containers are very tiny (e.g., less than 1 inch tall and ¼ inch across). In those situations, the barcodes and text on the drug container are very small. Other drug containers can have barcodes and/or text that are ten times larger. The system works for all these sizes of drug containers.
When using a camera to decode very tiny barcodes on small drug containers, camera focus is very important. The system has either a sufficiently good auto-focus system or a way that all drug containers can be presented to the camera at a fixed focal length.
The system works with the lights off in the room. So some type of lighting for the camera is provided that does not interfere with surgeons doing robotic surgery.

Capturing the expiration date and lot number with the NDC number is extremely useful. For example, by scanning a drug vial before use, an anesthesia provider or nurse can confirm that they have the drug they were intending to use.

The system can automatically check if the drug is expired and warn the user. Furthermore, because the lot number is also captured, a system can use the information to automatically alert the user of a drug recall by referencing a database of FDA drug recalls.

The system can also reference the lot number to an approved list by the FDA that authorizes use beyond the printed expiration date on the drug container. The user can be alerted to the new expiration date, and warned if it is still expired, e.g., past the extended expiration date. The system can automatically record the lot number of the drug used, so that, if there is a recall in the future, patients can be notified that were given the affected lot numbers.

Inventory systems can use the system in lieu of a barcode scanner to alert the user to drugs in the inventory that have expired or been recalled.

Many medical systems now allow the user to manually record the lot number of the drugs administered to patients. However, this is prone to error. The lot number is written in tiny letters on the drug container, and there is no standard font. It is difficult to distinguish between the number 0 and the letter O and between the number 1 and the lower case letter I. Some drug manufacturers put dashes in the lot number that is written on the drug container. However, the lot number does not contain these characters. (The dashes are inserted to make it easier for humans to read the lot number.)

By having a system that automatically reads lot numbers and makes sure they have been previously verified ensures every lot number is recorded correctly.

A system that automatically reads the expiration date from a drug container eliminates mistakes in interpreting when a drug is actually expired. Many drug containers contain only the month and year of the expiration date, leaving the exact date of expiration uncertain. The full expiration data might be contained only in a 2D barcode. If the system is doing verification on the human-readable information, then the expiration date is always interpreted correctly. The system eliminates mistakes in interpreting the expiration date.

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

Disclosed are systems and methods that can be used to read the machine-readable code and human-readable information from a container and verify that the human-readable information has been read accurately by comparing it to known datasets associated with the machine-readable code. One embodiment of the system can be used to accurately read the NDC number, the expiration date, and the lot number from a drug container.

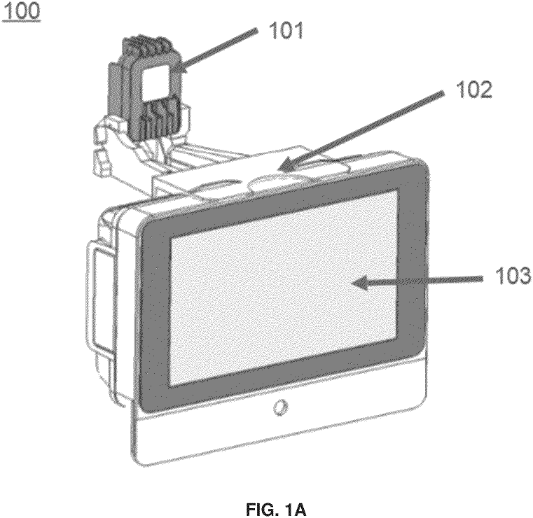

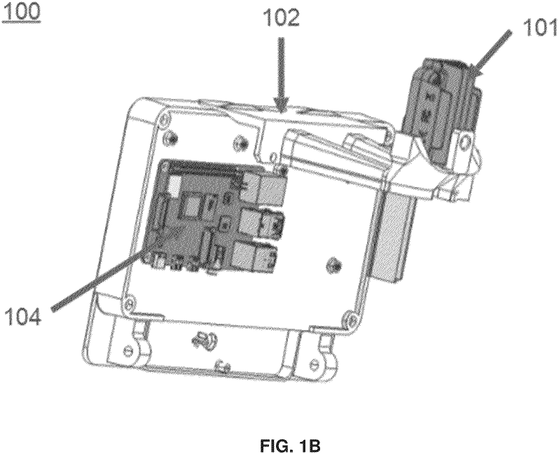

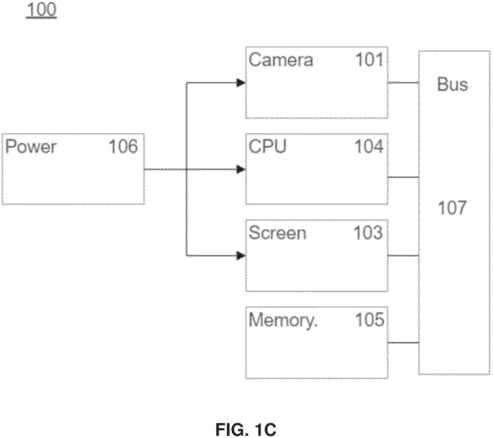

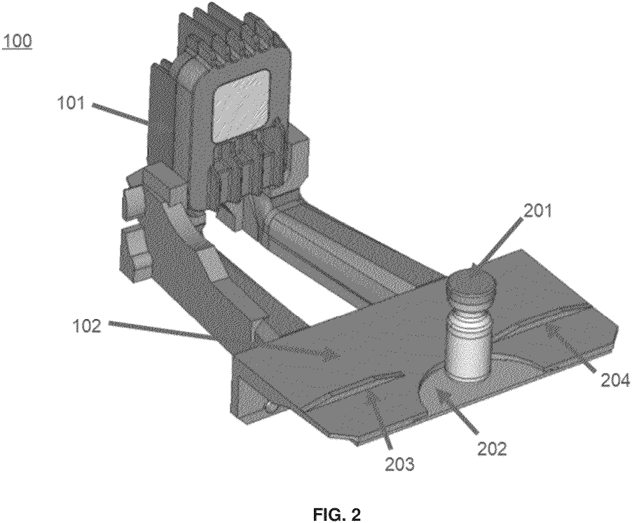

FIGS. 1A and 1B show the scanning system 100, having a camera 101, a holder 102, a screen (interactive display) 103, and a processor 104. FIG. 1C is a block diagram of the scanning system 100 of FIGS. 1A and 1B. FIG. 2 shows a partial view of the system 100 with a drug container 201, placed in the field of view of the camera 101, guided by the semi-circular cut-out 202 in the holder 102.

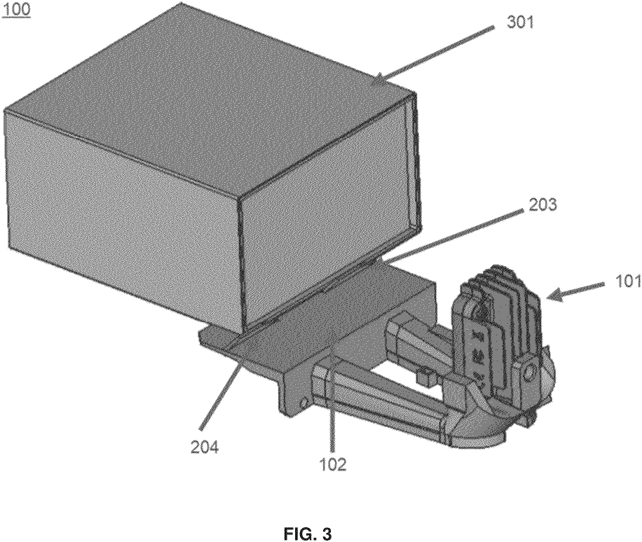

The camera 101 is held in a fixed position. The drug container 201 is placed in the field of view of the camera 101 by the user, onto the holder 102. The holder 102 has some special design features to assist the user in presenting the drug container 201 to the field of view of the camera 101. The semi-circular cut-out 202 in the holder 102 provides a resting place for a cylindrical drug container 201. It presents the drug container 201 at a fixed focal distance from the camera 101, allowing the camera 101 to have a minimal auto-focus system, or even fixed focal length. The cut-out 202 also keeps the drug container 201 in the field of view of the camera 101 when the user rotates the drug container 201. The ridges 203, 204 are used to guide the operator when presenting a rectangular drug container 301 to the camera 101, as shown in FIG. 3. The ridges 203, 204 stop the rectangular drug container 301 at the same fixed focal distance from the camera 101 as the cut-out 202.

As shown in FIG. 1C, the scanning system 100 includes the processor (e.g., CPU) 104, the camera 101, the screen 103, a memory module 105, a power source 106 providing electrical power for other components, and a bus 107 enabling communication between the interconnected components. The processor 104 controls the generation of images (e.g., video or still photos) by the camera 101 and receives and processes those images to generate displays shown on the screen 103. Those images and displays may be stored in the memory module 105. In some implementations, the power source 106 is a plug that may be plugged into a wall socket to power the scanning system 100. In other implementations, the power source 106 may include a battery for portable operation. Although not shown in FIG. 1C, the CPU 104 has at least one input/output (I/O) port enables information to be input to and/or output from the scanning system 100.

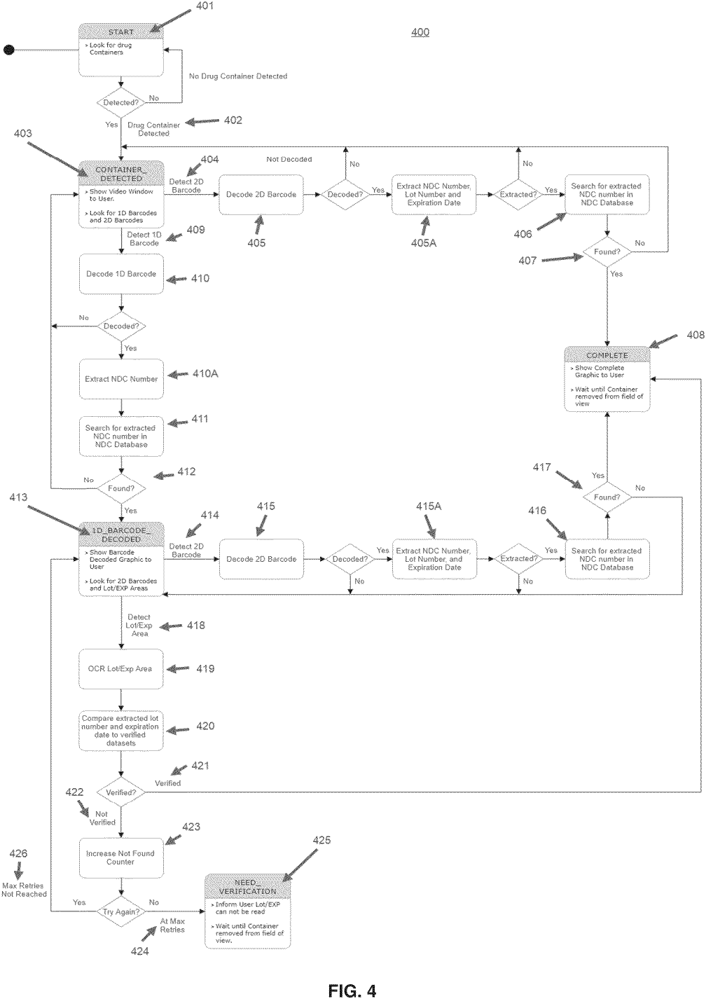

The processor 104 executes a state machine 400 (FIG. 4) to guide the actions of the system 100 and the feedback displayed on the screen 103 to the user when scanning a drug container 201 (or equivalently 301). When no drug container is detected in the camera 101 field of view for more than a preset time, typically 0.5 s - 1.0 s, the state machine 400 resets to the START State 401.

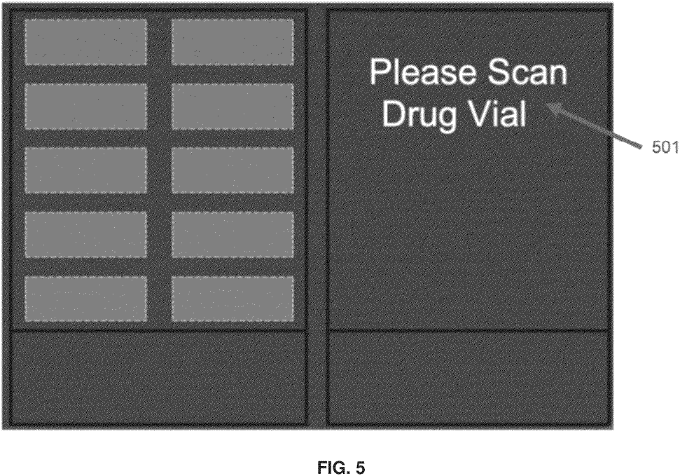

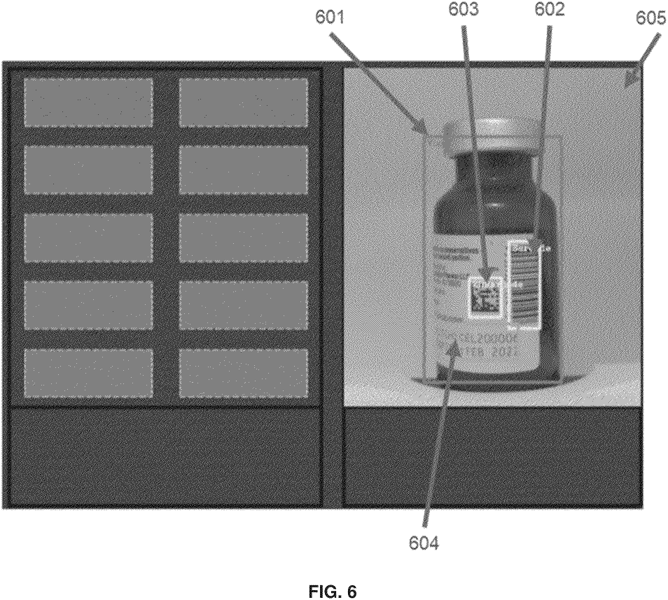

In the START State 401, the system 100 informs the user that it is ready to scan a drug container 201 by displaying a message 501 to the user, as shown in FIG. 5. The system continuously scans the camera 101 field of view to detect objects 601, 602, 603, 604 in the image stream provided by the camera 101, as shown in FIG. 6. One possible implementation of a system to detect objects 601, 602, 603, 604 is to use a neural network to detect the objects 601, 602, 603, 604. The system 100 can detect areas on the image that are drug container objects 601, 1D barcodes 602, 2D barcodes 603, and the area on the drug container 201 where the lot number and expiration date (LOT/EXP area 604) are written. Examples of possible neural network models that can be trained to recognize these objects 601, 602, 603, 604 include YOLO (You Only Look Once), R-CNN (Region Based Convolutional Neural Network), MobileNet, SSD (Single Shot Detector), and RetinaNet, which are terms used in the Al field to refer to different design architectures of neural networks for which there may be software code available at open-source websites and published papers on their performance.

When the system 100 detects 402 a drug container object 601 in the field of view of camera 101, the state machine 400 transitions to the CONTAINER_DETECTED State 403 and the operator is notified by a video window 605 appearing on the screen 103 that (i) displays what the camera 101 is seeing, as shown in FIG. 6, and (ii) outlines the objects 601, 602, 603, 604 in the field of view that the system 100 has detected in the image. The video window 605 should operate at a minimum of about 10 FPS (frames per second) refresh rate, so that the user can get accurate feedback on what the camera 101 is seeing.

In the CONTAINER_DETECTED State 403, the system 100 is searching for a 1D barcode 602 or 2D barcode 603 on the drug container 201. If the system 100 detects 404 a 2D barcode 603, then the system 100 tries to decode 405 the 2D barcode 603. There are numerous commercial and open-source algorithms that can be employed to decode 405 a 2D barcode 603 from an image. For example, Dynamsoft of Vancouver, Canada, and LEADTOOLS of Charlotte, North Carolina, sell software development kits for decoding barcodes. If the system cannot successfully decode 405 the 2D barcode 603, then the system 100 remains in the CONTAINER_DETECTED State 403 and waits until the camera 101 delivers another image to process. If the system 100 successfully decodes 405 the 2D barcode 603, then the system 100 will attempt to extract 405A the NDC number, lot number, and expiration date from the barcode data. 2D barcodes 603 on drug containers 201 in the U.S. follow the GS1 healthcare standard (gs1.org). This standard defines four fields in the barcode data, which are the GTIN, the expiration date, lot number, and serial number. The NDC number is contained in the GTIN field. The system 100 extracts 405A the NDC number from the GTIN field. Sometimes manufacturers place a 2D barcode 603 on a drug container 201 where the 2D barcode 603 is not GS1 compliant. If the 2D barcode 603 is not GS1 compliant, then the system 100 remains in the CONTAINER_DETECTED State 403 and waits until the camera 101 delivers another image to process.

Once an NDC code is extracted 405A from the barcode data, the system searches the NDC database 406 to try to find an NDC number in the NDC database that matches the extracted NDC number from the barcode data. If the 2D barcode 603 does not contain 407 a NDC number from the NDC database, then the system 100 remains in the CONTAINER_DETECTED State 403 and waits until the camera 101 delivers another image to process.

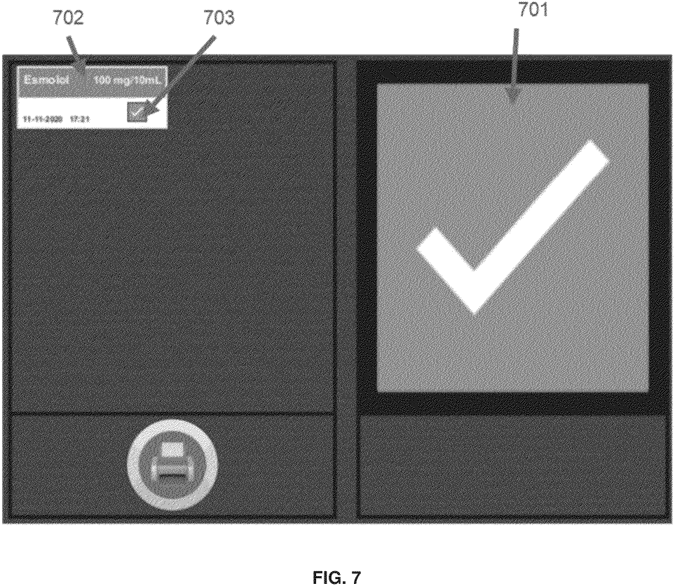

If the 2D barcode 603 contains 407 an NDC number found in the NDC database, then the system 100 transitions to the COMPLETE State 408, and the user is alerted that the drug container 201 has been successfully read. This is shown in FIG. 7. The video window 605 is no longer shown, only the “successful scan” icon 701. Also, the descriptive label 702 of the drug can be shown on the screen with a green check mark 703. This notifies the user that the drug container 201 has been successfully scanned with the verified lot number and expiration date displayed on the screen.

If the system 100 does not detect 404 a 2D barcode 603, but does detect 409 a 1D barcode 602, then the system 100 tries to decode 410 the 1D barcode 602. There are numerous commercial and open-source algorithms that can be employed to decode 410 a 1D barcode 602 from an image. For example, Dynamsoft of Vancouver, Canada, and LEADTOOLS of Charlotte, North Carolina, sell software development kits for decoding barcodes. If the system cannot successfully decode 410 the 1D barcode 602, then the system 100 remains in the CONTAINER_DETECTED State 403 and waits until the camera 101 delivers another image to process.

If the system 100 successfully decodes 410 the 1D barcode 602, then the system 100 extracts 410A the NDC number from the barcode data. There are several 1D barcode 602 standards used on drug containers in the US, including UPC-A, Code 128, Code 39, and a few others. The algorithm used to decode 410 the 1D barcode 602 also determines the barcode type. The system uses the 1D barcode 602 type to determine how to extract 410A the NDC code from the barcode data.

The system 100 then searches 411 the NDC database for the extracted NDC number. If the system 100 does not find 412 the extracted NDC number in the NDC Database, then the system 100 remains in the CONTAINER_DETECTED State 403 and waits until the camera 101 delivers another image to process.

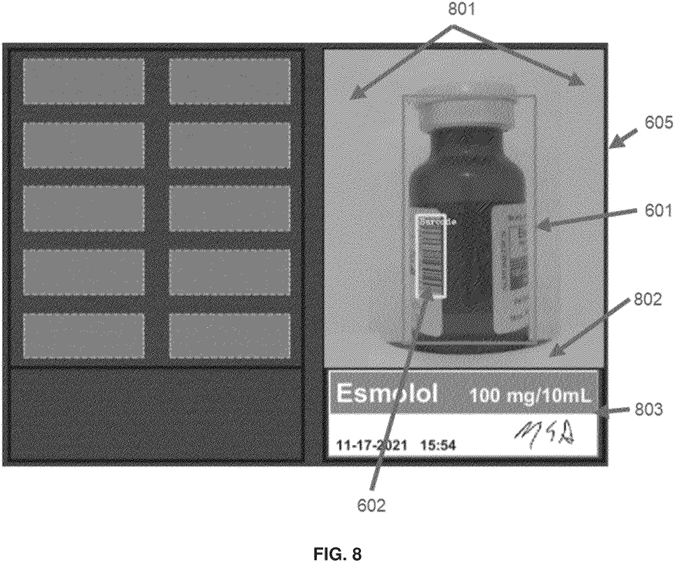

If the 1D barcode 602 contains 412 an NDC number contained in the NDC database, then the system 100 transitions to the 1 D_BARCODE_DECODED State 413 and provides visual feedback to the operator, comprised of green vertical stripes 801 on the right and left edges of the video window 605 and a very light green background 802 on the rest of the image as shown in FIG. 8. The name and dose of the drug 803 are extracted from the NDC database and displayed on the screen 103. This feedback informs the user that the 1D barcode 602 has been read, and now the system 100 is attempting to read the lot number and expiration date from the drug container 201.

Because the drug container 201 can be very small, the lot number and/or the expiration date might not be able to be read from the same image that the 1D barcode 602 was read 412 from. In that case, the drug container 201 needs to be rotated so that the LOT/EXP Area 604 becomes visible in the field of view of the camera 101, and the lot number and expiration date can be read by the system 100. By informing the user that the 1D barcode 602 has been read 412 and still showing them the video window 605 with the objects 601, 602, 603, 604 detected, the user can rotate the drug container 201 to allow the lot number and expiration date to become visible to the camera 101. Without the visual feedback 605 to the user, it becomes difficult for the user to rotate the drug container 201 so that the system 100 can fully read the lot number and expiration date.

In the 1 D_BARCODE_DECODED State 413, the system is now actively searching for a 2D barcode 15 and a LOT/EXP Area 17. Steps 414-417 are identical to steps 404-407. If there is no 2D barcode or if the 2D barcode 603 does not contain 417 a NDC number found in the NDC database, then the system 100 remains in the 1 D_BARCODE_DECODED State 413 and waits until the camera 101 delivers another image to process.

The system 100 has a database (LOT/EXP Database) of verified lot number / expiration date pairs associated with a NDC code, e.g., stored in memory module 105. The LOT/EXP Database is used to verify 420 the lot number and expiration date extracted by OCR 419. This database is populated automatically by the system 100 when it successfully scans a 2D barcode 603 containing a NDC number, lot number, and expiration date.

If the system detects 418 a LOT/EXP Area 604, then it will utilize OCR 419 to extract the text from this area and compare 420 the extracted lot number and expiration date from the drug container 201 with the LOT/EXP Database of known lot number and expiration date pairs that have been previously validated by the system 100. If the lot number and expiration date are verified 421, then the state machine transitions to the COMPLETE State 408, and the user is alerted that the drug container 201 has been successfully read. This is shown in FIG. 7.

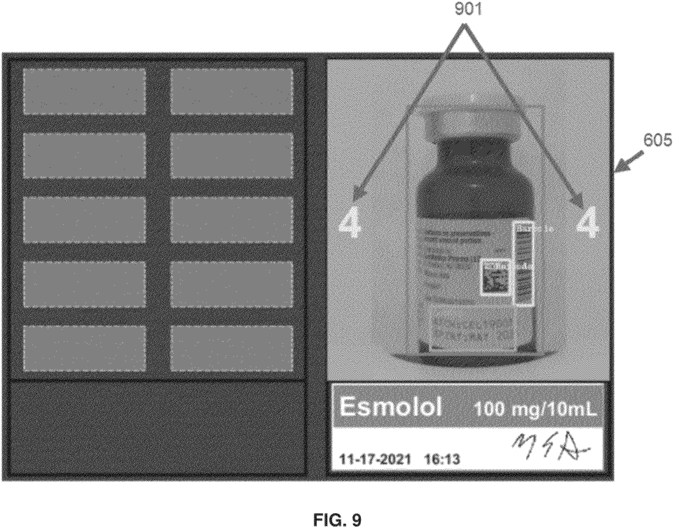

If the lot number and expiration date cannot be verified 422, then the system increments 423 a counter. The value of the counter 901 is displayed in the video window 605 to the user so they can see the system 100 is trying to read the lot number and expiration date, as shown in FIG. 9. If the counter 901 is at a specified maximum number of retries 424 (typically set at a value of 10), then the system 100 will transition to NEED_VERIFICATION State 425. If the counter 901 is less than the maximum number of retries 426, then the system 100 remains in the 1D_BARCODE_DECODED State 413. The counter 901 informs the user on what the system 100 is doing. If the counter 901 is not incrementing, then the system 100 is not detecting a LOT/EXP Area 604. This informs the user that they need to better position the drug container 201. If the counter 901 is incrementing, then the user knows the system 100 is trying to read the lot number and expiration date, and they can stop moving the drug container 201.

In the COMPLETE State 408, the system 100 has successfully scanned a drug container 201 and obtained the NDC code, the lot number, and the expiration date of the drug container 201. The user is alerted that the drug container 201 has been successfully read. This is shown in FIG. 7. The video window 605 is no longer shown, only the “successful scan” icon 701. Also, the descriptive label 702 of the drug can be shown on the screen with a green check mark 703. This notifies the user that the drug container 201 has been successfully scanned with a verified lot number and expiration date. The system 100 will not scan another drug container 201 until the operator removes the drug container 201 from the field of view of the camera 101. After a preset time of not detecting a drug container 201 (typically 0.5 - 1 seconds), the success icon 701 is taken away from the screen, and the state machine 400 transitions to the START State 401.

When system 100 enters the COMPLETE State 408, the system 100 will do the following checks:

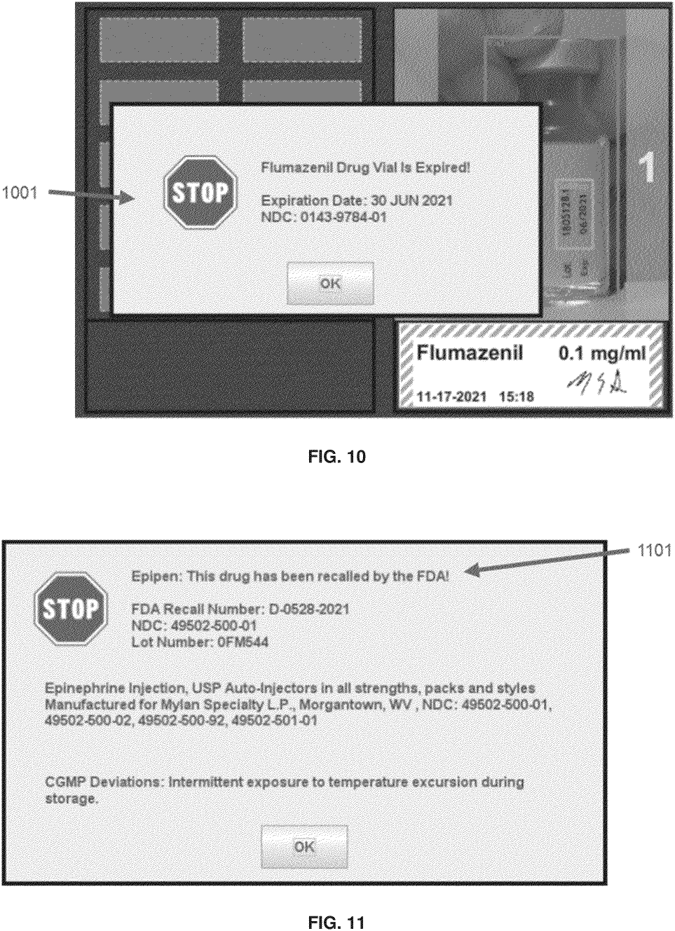

1. Check if the scanned drug container 201 is expired by comparing the expiration date on the drug container 201 to the current date. If the drug container 201 is expired, then a message 1001 is shown on the screen 103 to the user, as shown in FIG. 10.

2. Check if the scanned drug container 201 has been recalled by the FDA by referencing the NDC number and lot number to a database of recalled drugs held in the memory of the system 100. If the drug container 201 has been recalled by the FDA, then a message 1101 is shown on the screen 103 to the user, as shown in FIG. 11.

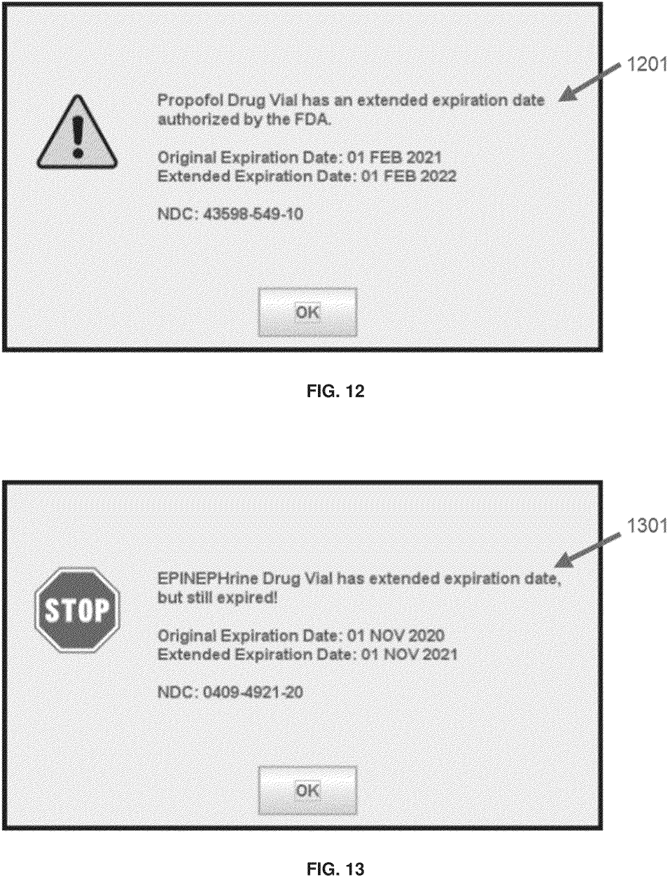

3. Check if the scanned drug container 201 has an extended expiration date authorized by the FDA by referencing the NDC number and lot number on the drug container 201 to a database of extended expiration dates held in the memory of the system 100. If the drug container 201 has an extended expiration date authorized by the FDA, then a message 1201 is shown on the screen 103 to the user, as shown in FIG. 12.

4. Check if the scanned drug container 201 has an extended expiration date authorized by the FDA, but the drug container is still expired (i.e., past the extended expiration date) by referencing the NDC number and lot number on the drug container 201 to a database of extended expiration dates held in the memory of the system 100. If the drug container 201 has an extended expiration date by the FDA but is still expired, then a message 1301 is shown on the screen 103 to the user, as shown in FIG. 13.

If the system 100 reaches the COMPLETE State 408 by scanning a 2D barcode 603, then the NDC Code, lot number, and expiration date that are read from the 2D barcode 603 are stored to the LOT/EXP Database of verified lot number / expiration date pairs. This allows the system 100 in the future to scan a drug container 201 with a 1D barcode 602 and verify the same lot number and expiration date written on the drug container 201 in human-readable form.

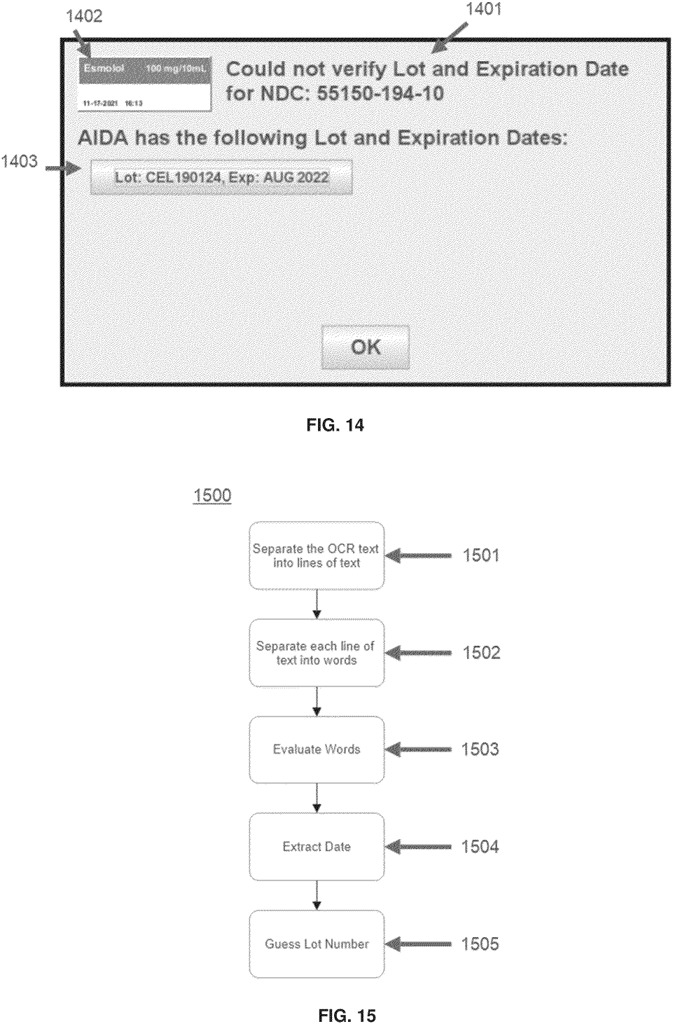

In the NEED_VERIFICATION State 425, the system 100 has reached its retry limit 424 and has been unable to verify the human-readable information on the drug container 201. The system 100 will inform the operator that the lot number and expiration date were not read successfully by the system 100, as shown in FIG. 14. The message 1401 includes the name of the drug 1402, and the lot number / expiration pairs 1403 the system 100 has previously verified from the LOT/EXP Database. The system 100 will not scan another drug container 201 until the operator acknowledges the message by clicking on “OK” and removes the drug container 201 from the field of view of the camera 101. After a preset time of not detecting a drug container 201 (typically 0.5 - 1 seconds), the state machine 400 transitions to the START State 401.

The following method is just one example on how to perform OCR 419 on the LOT/EXP Area 604.

The system 100 creates a sub-image of the area of the camera 101 image that has been detected by the neural network to contain the LOT/EXP Area 604. This sub-image is then pre-processed to improve the OCR 419 results. Examples of pre-processing include, but are not limited to: Rotate text to be horizontal; Remove shadow from the image; Detect inverse writing and invert (white text on black background); Remove convex from the image of a curved drug container 201. Such pre-processing may be implemented using open-source software, such as routines found in the openCV library (https://opencv.org/). The open-source OCR software library Tesseract (https://tesseract-ocr.github.io/) has a routine that determines the angle at which text is written in an image. The openCV rotate function can then be used to rotate the image to provide straight text for the OCR software.

OCR relies on the contrast between characters and background to work properly. To improve performance of the OCR, shadows can be removed from an image using several of the openCV functions, including the cvtColor() function to change an image to grayscale and create a structuring element used to average the contrast of different areas using the dilate(), medianblur(), absdiff(), and bitwisenot() functions.

OCR assumes black writing on white background. Some drug vials have white writing on a black background. Such an image should be inverted before putting the image through OCR. To detect inverse writing the openCV mean() function can be used to determine the average brightness of all the pixels in the image that is then compared to a threshold to determine if the image is white on black or black on white. If needed, the openCV bitwise_not() function can be used to reverse the image.

To remove convex from an image, assume that the middle of the image is correct and rotate the outer edges of the image down using the openCV warpPerspective() function on opposing halves of the image, and then recombine with the openCV function hconcat() function.

To increase the speed of OCR, an image can be made smaller using the openCV function resize().

After pre-processing, the sub-image is passed into an OCR engine. There are numerous commercial and open-source algorithms that can be employed to OCR text from an image. For example, Dynamsoft of Vancouver, Canada, and ABBYY of Milpitas, California, sell software development kits for OCR. The text output from the OCR engine must then be evaluated to determine if it contains a valid lot number and/or valid expiration date.

FIG. 15 shows one such implementation of an algorithm 1500 to extract lot number and expiration date from the output text of an OCR engine. In step 1501, the algorithm 1500 separates the OCR text into individual lines of text, with carriage return being used as the separator. In step 1502, the algorithm 1500 separates each line of text into words, with whitespace being used as the separator. In step 1503, the algorithm 1500 evaluates each word as one of the following:
A number
A name of a month, e.g. “JAN”, “FEB”, etc.
A keyword indicating lot number, e.g. “LOT”, “BATCH”, etc.
A keyword indicating expiration date, e.g. “EXP” “EXPIRY”, etc.
In step 1504, the algorithm 1500 evaluates all the words from each line to extract an expiration date. Many date formats have to be checked, including, but not limited to:

| | |
|---|---|
| Format: | Example: |
| MM/YYYY | 07/2020 |
| MM/YY | 07/20 |
| MM/DD/YYYY | Jul. 16, 2020 |
| MMMYYYY | JUL2020 |
| DDMMMYYYY | 16JUL2020 |

In step 1505, the algorithm 1500 evaluates any remaining words that did not contain date data or keywords and attempts to guess if one of these words are the lot number. Starting with the first line in the image, the algorithm 1500 checks each remaining word to the following requirements:
Be at least 3 characters in length; and
Cannot contain the “/” character.
The first remaining word that meets these requirements is guessed as the lot number.

The following method is just one example on how to compare the extracted lot number and expiration date to verified datasets in step 420 of FIG. 4.

Typical accuracy rates of modern OCR systems are over 95%, and some state-of-the-art systems now achieve 99.8% accuracy on text. These systems achieve this with entire word recognition and spell-check dictionaries. Neither of these methods can be applied to reading a lot number, which is a random set of numbers and characters. Even with 95% accuracy, 1 in 20 lot numbers will be scanned incorrectly by an OCR system. This is an unacceptable error rate when you are recording lot numbers to check for drug recalls. In contrast, the worst-case error rate for reading a 2D barcode 603 is less than 1 in 10,000,000. Some type of verification system is used to ensure that the lot number and expiration date extracted by algorithm 1500 from OCR in step 419 of FIG. 4 are accurate.

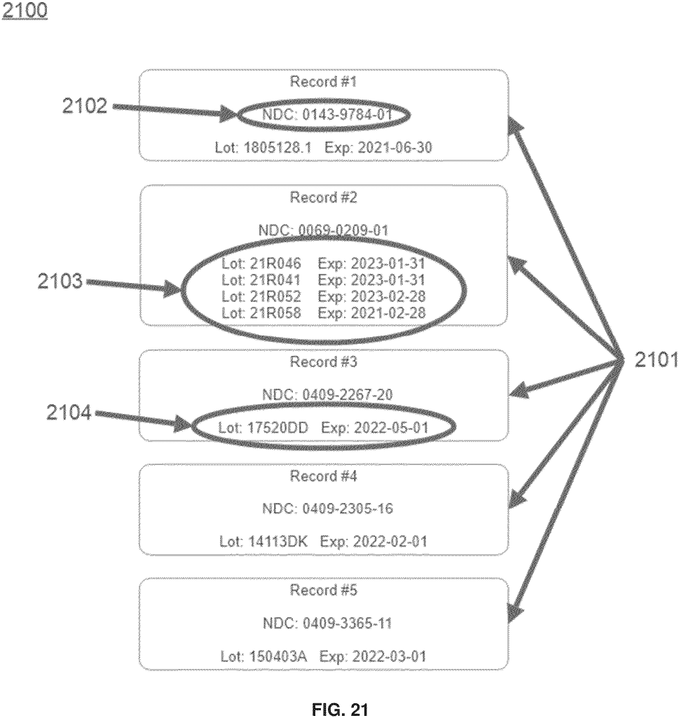

The system 100 solves the OCR accuracy problem by using an internal LOT/EXP Database 2100, as shown in FIG. 21. Each record 2101 of the LOT/EXP Database 2100 has a unique NDC Number 2102. Each record 2101 also contains lot number / expiration date pairs 2103 that are valid for the NDC number 2102. A record 2101 must have a minimum of one lot number / expiration date pair 2104. There is no maximum limit on the number of lot number / expiration date pairs 2103 the record contains. However, each record 2101 must have a unique NDC number 2102.

The system 100 populates the LOT/EXP Database 2100 from successfully scanned 2D barcodes 603. Alternatively, the records 2101 in the LOT/EXP Database 2100 can be provided to the system 100 in another way, e.g., by the drug manufacturer, or provided by other instances of the system 100 linked with an internet connection. The system 100 can then use the LOT/EXP Database 2100 to verify the extracted 1500 lot number and expiration date from OCR 419 text based on some rules to ensure accuracy.

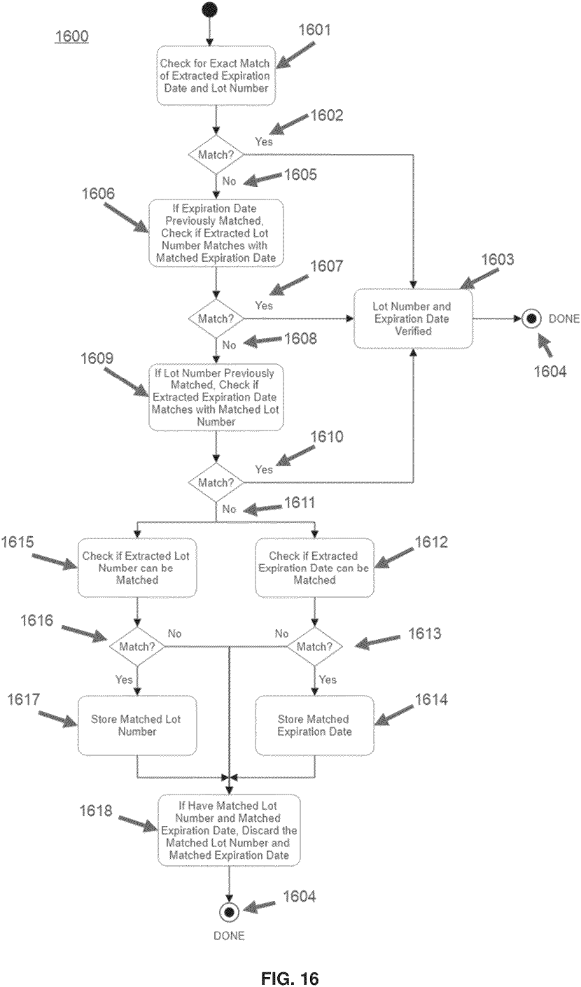

FIG. 16 shows one such implementation of an algorithm 1600 to verify the lot number and expiration date extracted 1500 from OCR 419 text.

The system 100 knows the NDC number 2102 from the decoded 1D barcode 602. The system 100 also holds a database (LOT/EXP Database 2100) of verified lot number and expiration date pairs 2103 associated with the NDC number 2102. These verified lot number / expiration date pairs 2103 are the only lot numbers and expiration dates that the system will read from a drug container 201 with a 1D barcode 602.

The verification algorithm 1600 can be likened to spellcheck for the OCR 419 text. The system 100 can read a lot number / expiration date pair only for a specific NDC code 2102 that is stored in the LOT/EXP Database 2100. If the lot number and expiration date written on the drug container 201 are not in the LOT/EXP Database 2100, then the system 100 will not recognize them. However, many times, the results of the OCR 419 text are not completely accurate. That is why the system 100 will try a specified number of times to OCR 419 the LOT/EXP area 604 before failing. The verification algorithm 1600 can use OCR 419 text from several images to improve recognition of known lot number / expiration date pairs 2103.

Now that the OCR 419 has been processed, the system 100 attempts to validate the extracted 1500 lot number and expiration date from the LOT/EXP Area 604. The algorithm 1600 does the following:

Compares 1601 the lot number and expiration date extracted 1500 from the LOT/EXP Area 604 of the current image to the known lot number / expiration date pairs 2103 stored in the LOT/EXP Database 2100 linked to the NDC code 2102. If both the expiration date and lot number match 1602 a LOT/EXP Database entry 2101, then the lot number and expiration date are verified 1603 and the algorithm is done 1604. If one or both do not match 1605, then the following step occurs:

If the algorithm 1600 stored 1614 a matched expiration date from a previous image, then the algorithm 1600 compares 1606 the extracted 1500 lot number and previously matched expiration date to the known lot number / expiration date pairs 2103 stored in the LOTEXP Database 2100 linked to the NDC code 2102. If both the expiration date and lot number match 1607 a LOTEXP Database entry 2101, then the lot number and expiration date are verified 1603 and the algorithm is done 1604. If they do not both match 1608, then the following step occurs:

If the algorithm 1600 stored 1617 a matched a lot number from a previous image, then the algorithm 1600 compares 1609 the extracted 1500 expiration date and previously matched lot number to the known lot number / expiration date pairs 2103 stored in the LOTEXP Database 2100 linked to the NDC code 2102. If both the expiration date and lot number match 1610 a LOTEXP Database entry 2101, then the lot number and expiration date are verified 1603 and the algorithm is done 1604. If they do not both match 1611, then the following steps occur:

Compares 1612 the expiration date extracted 1500 from the LOT/EXP Area 604 to the known expiration dates in the LOT/EXP database 2100 linked to the NDC code. If an exact match 1613 is found (i.e., day, month, and year all match), then the algorithm 1600 stores 1614 the matched expiration date.

Compares 1615 the lot number extracted 1500 from the LOT/EXP Area 604 to the known lot numbers in the LOT/EXP database 2100 linked to the NDC code. If an exact match 1616 is found (i.e., all characters match and the length is the same), then the algorithm 1600 stores 1617 the matched lot number.

If the algorithm 1600 has stored 1617 a matched lot number and has stored 1614 a matched expiration date, then the stored matched lot number and matched expiration date are discarded 1618. This is done because the one of them must be wrong, since the algorithm 1600 has already checked if the matched lot number and matched expiration date are in the same entry in the LOT/EXP Database 2100. The algorithm 1600 is done 1604 without verifying the lot number and expiration date.

The algorithm 1600 stores 1617, 1614 matched lot numbers and expiration dates so that the system 100 can verify a lot number from one image with an expiration date acquired in a different image. This enhances the usability of the system 100. The algorithm 1600 can be further enhanced by making corrections to the guessed lot number by changing the letter O to the number 0, or changing the number 0 to the letter O and processing the algorithm 1600 again.

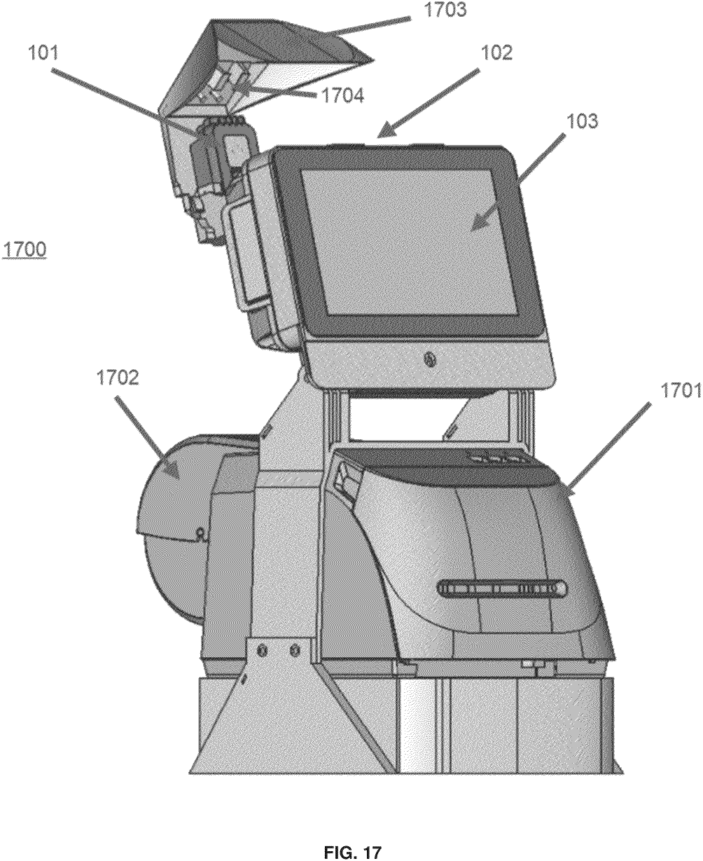

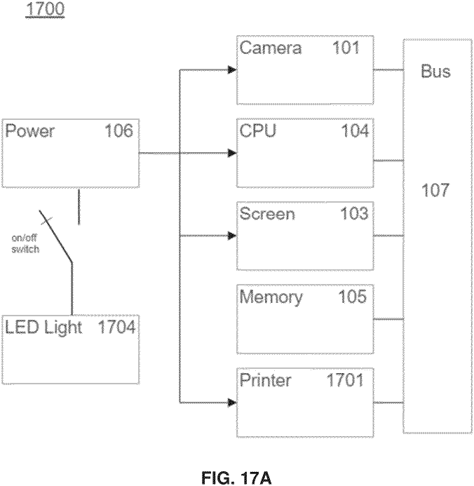

The scanning system 100 can be incorporated into a labeling system 1700 used to generate labels for drug syringes. FIGS. 17 and 17A show a labeling system 1700 that includes the scanning system 100 mounted to a printer 1701 used to print labels on demand. The printer 1701 has a holder 1702 to hold a roll of labels (not shown). These labels can be applied to syringes used by an anesthesiologist or a nurse anesthetist in their procedures. In the prior art, when a nurse anesthetist or anesthesiologist prepares their syringes for a procedure, they apply paper labels onto a syringe and then they draw the drug into the syringe from a drug vial. These labels are color coded based on the drug type, and have blanks for the date/time, dosage, and initials of the preparer. These blanks are conventionally filled in by the nurse anesthetist or anesthesiologist. Because this is a manual process and the labels are color coded, the nurse anesthetist or anesthesiologist sometimes does not fully fill out the label properly, which can lead to mistakes.

The labeling system 1700 enhances the scanning system 100 by adding a hood 1703 that provides mounting for an LED light 1704 to indirectly shine on the holder 102 of the scanning system 100. The LED light 1704 shines directly on the underside of the hood 1703, and the hood reflects the light onto the drug container 201. This allows the system 1700 to be used in low light or dark rooms. The LED light 1704 will illuminate the drug container 201 when it is presented to the field of view of the camera 101, so that the scanning system 100 can scan the drug container 201. An indirect lighting system is used so that the LED light 1704 will not shine into the eyes of the operator.

The labeling system 1700 uses the scanning system 100 to read the NDC number, expiration date, and lot number from a drug container 201. The system 1700 then references the NDC database to automatically create and print a label with the proper color coding and dosage, according to the international standard ASTM D4774 - 11 (2017). The NDC database has fields that specify the active agents in the drug, which can be used to determine the label color. The NDC database also has fields that specify the name and dosage of the drug. The system 1700 can recognize and create a properly colored label for any drug approved by the FDA without the user having to pre-configure any details about the drugs they utilize.

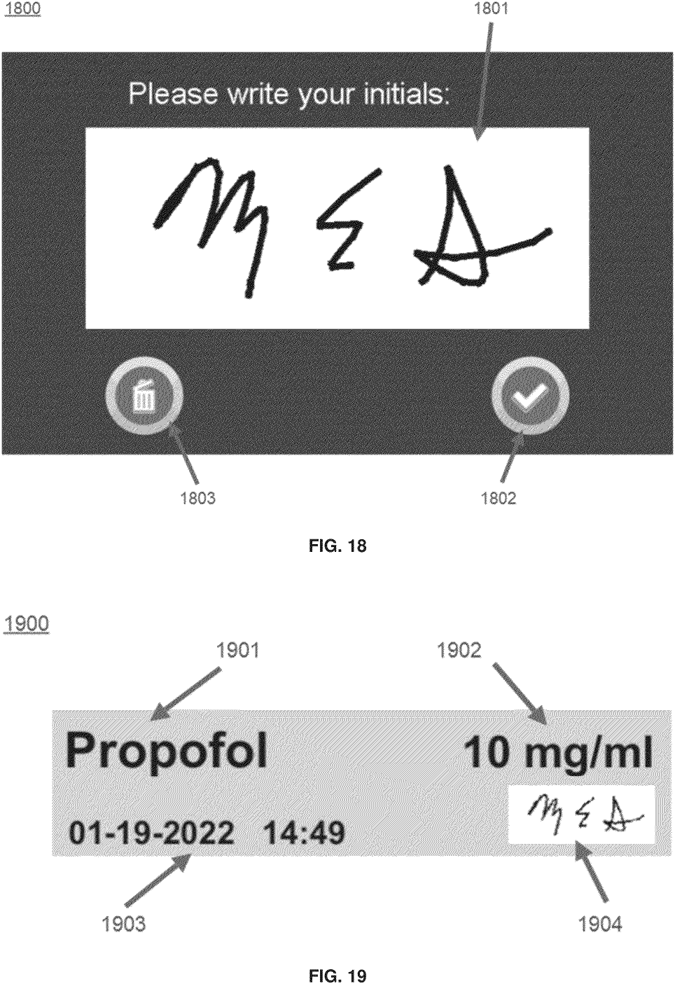

The labeling system 1700 utilizes a touchscreen for the screen 103. The anesthesiologist enters their initials when they begin to use the labeling system 1700. FIG. 18 shows the screen 1800 used to enter in the user initials. The screen 1800 has an area for the user to trace their initials 1801 using the touchscreen, a button to accept the written initials 1802, and a button to erase the initials 1803 if a mistake is made. The system 1700 fills in the correct time/date and applies the user initials to the label 1900 when it is printed. FIG. 19 shows an example of a printed label 1900. The label 1900 includes the name of the drug 1901, the dose 1902, date and time of preparation 1903, and the user initials 1904.

In certain embodiments, the present disclosure is a method of capturing human-readable text displayed on a container and verifying against a known data set using a device. The method comprises the device (i) capturing identification information associated with the container; (ii) electronically capturing the human-readable text on the container; and (iii) validating the human-readable text on the container against a verified database of valid values, linked to the identification information.

In at least some of the above embodiments, capturing the identification information comprises reading an identification code displayed on the container.

In at least some of the above embodiments, reading the identification code comprises using optical character recognition (OCR) to read a package label on the container.

In at least some of the above embodiments, capturing the identification information comprises scanning a machine-readable code on the container.

In at least some of the above embodiments, scanning the machine-readable code comprises using a neural network to detect an area on the container having the machine-readable code.

In at least some of the above embodiments, capturing the identification information comprises using visual object detection to identify the container based on its appearance.

In at least some of the above embodiments, locating the human-readable text on the container utilizes a neural network to detect an area on the container having the human-readable text to OCR.

In at least some of the above embodiments, after capturing the identification information, non-location-specific visual feedback is given to a human operator or electronic feedback is given to a machine to reposition at least one of the container and the device so that the human-readable information can be made visible to be read by the device.

In at least some of the above embodiments, after validating the human-readable text on the container, visual feedback to a human operator or electronic feedback to a machine is provided that the container has been successfully identified and the human-readable information has been verified.

In at least some of the above embodiments, the human-readable text comprises at least one of an expiration date and a lot number associated with the container.

In at least some of the above embodiments, electronically capturing the human-readable text comprises translating the human-readable text into machine-readable text using optical character recognition.

In at least some of the above embodiments, electronically capturing the human-readable text comprises translating the human-readable text on the container using neural network object detection to limit an area on an image of the container processed with optical character recognition.

In certain embodiments, the present disclosure is a system for capturing human-readable text displayed on a container and verifying against a known data set. The system comprises an image capture device configured to capture images of the container; a processor in communication with the image capture device; and a memory in communication with the processor, said memory storing an application executable by the processor, wherein the processor is configured, upon execution of the application, to (i) determine, based at least in part on identification information associated with the container, human-readable information associated with the identification information and (ii) to validate the human-readable information using a verified database of valid values.

In at least some of the above embodiments, the system further comprises a screen configured to provide visual feedback to an operator of the system.

In at least some of the above embodiments, the processor is further configured, upon execution of the application, to capture identification information associated with the container from an identification code displayed on the container.

In at least some of the above embodiments, in order to capture the identification information, the processor uses a neural network to detect an identification code on the container.

In at least some of the above embodiments, the processor is further configured, upon execution of the application, to use visual object detection to identify the container based on its appearance.

In at least some of the above embodiments, the processor uses a neural network to execute visual object detection.

In at least some of the above embodiments, the processor is further configured, upon execution of the application, to locate the human-readable text on the container utilizing a neural network.

In at least some of the above embodiments, after capturing the identification information, non-location-specific visual feedback is given to a human operator or electronic feedback is given to a machine to reposition at least one of the container and the system so that the human-readable information can be made visible to be read by the system.

In at least some of the above embodiments, after validating the human-readable text on the container, the processor provides visual feedback to a human operator or electronic feedback to a machine that the container has been successfully identified and the human-readable information has been verified.

In at least some of the above embodiments, the valid human-readable information associated with the identification comprises at least one of an expiration date and a lot number associated with the container.

In certain embodiments, the present disclosure is an apparatus for capturing human-readable text displayed on a container. The apparatus comprises means for capturing identification information associated with the container; means for electronically capturing the human-readable text on the container; and means for validating the human-readable text on the container against a known data set of valid values, linked to the identification information.

In at least some of the above embodiments, the human-readable text comprises at least one of an expiration date and a lot number associated with the container.

In at least some of the above embodiments, the means for electronically capturing the human-readable text comprises means for translating the human-readable text into machine-readable text using optical character recognition.

In at least some of the above embodiments, the means for electronically capturing the human-readable text further comprises means for translating the human-readable text on the container using neural network object detection to limit an area on an image of the container processed with optical character recognition.

In certain embodiments, the present disclosure is a non-transitory computer program product for capturing human-readable text displayed on a container, wherein the computer program product comprises at least one computer-readable storage medium having computer-readable program code portions stored therein. The computer-readable program code portions comprise a first executive portion for identifying areas of interest on an image of the container; a second executable portion for directing the capture of identification information associated with the container; a third executable portion for directing the electronic capture of the human-readable text; and a fourth executable portion for validating the human-readable text, wherein the container identification information is used to reference a database of valid human-readable values for the container.

In at least some of the above embodiments, the third executable portion is configured to translate the human-readable text into machine-readable text using optical character recognition.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits.

The term “non-transitory,” as used herein, is a limitation of the medium itself (i.e., tangible, not a signal) as opposed to a limitation on data storage persistency (e.g., RAM vs. ROM).

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method of capturing human-readable text displayed on a container and verifying against a known data set using a device, said method comprising the device:
capturing identification information associated with the container;
electronically capturing the human-readable text on the container; and
validating the human-readable text on the container against a verified database of valid values, linked to the identification information.

2. The method of claim 1, wherein capturing the identification information comprises reading an identification code displayed on the container.

3. The method of claim 2, wherein reading the identification code comprises using optical character recognition (OCR) to read a package label on the container.

4. The method of claim 1, wherein capturing the identification information comprises scanning a machine-readable code on the container.

5. The method of claim 4, wherein scanning the machine-readable code comprises using a neural network to detect an area on the container having the machine-readable code.

6. The method of claim 1, wherein capturing the identification information comprises using visual object detection to identify the container based on its appearance.

7. The method of claim 1, wherein locating the human-readable text on the container utilizes a neural network to detect an area on the container having the human-readable text to OCR.

8. The method of claim 1, wherein, after capturing the identification information, non-location-specific visual feedback is given to a human operator or electronic feedback is given to a machine to reposition at least one of the container and the device so that the human-readable information can be made visible to be read by the device.

9. The method of claim 1, wherein, after validating the human-readable text on the container, providing visual feedback to a human operator or electronic feedback to a machine that the container has been successfully identified and the human-readable information has been verified.

10. The method of claim 1, wherein the human-readable text comprises at least one of an expiration date and a lot number associated with the container.

11. The method of claim 1, wherein electronically capturing the human-readable text comprises translating the human-readable text into machine-readable text using optical character recognition.

12. The method of claim 1, wherein electronically capturing the human-readable text comprises translating the human-readable text on the container using neural network object detection to limit an area on an image of the container processed with optical character recognition.

13. A system for capturing human-readable text displayed on a container and verifying against a known data set, said system comprising:
an image capture device configured to capture images of the container;
a processor in communication with the image capture device; and
a memory in communication with the processor, said memory storing an application executable by the processor, wherein the processor is configured, upon execution of the application, to (i) determine, based at least in part on identification information associated with the container, human-readable information associated with the identification information and (ii) to validate the human-readable information using a verified database of valid values.

14. The system of claim 13, further comprising a screen configured to provide visual feedback to an operator of the system.

15. The system of claim 13, wherein the processor is further configured, upon execution of the application, to capture identification information associated with the container from an identification code displayed on the container.

16. The system of claim 15, wherein, in order to capture the identification information, the processor uses a neural network to detect an identification code on the container.

17. The system of claim 13, wherein the processor is further configured, upon execution of the application, to use visual object detection to identify the container based on its appearance.

18. The system of claim 17, wherein the processor uses a neural network to execute visual object detection.

19. The system of claim 13, wherein the processor is further configured, upon execution of the application, to locate the human-readable text on the container utilizing a neural network.

20. The system of claim 13, wherein, after capturing the identification information, non-location-specific visual feedback is given to a human operator or electronic feedback is given to a machine to reposition at least one of the container and the system so that the human-readable information can be made visible to be read by the system.

21. The system of claim 13, wherein, after validating the human-readable text on the container, the processor provides visual feedback to a human operator or electronic feedback to a machine that the container has been successfully identified and the human-readable information has been verified.

22. The system of claim 13, wherein the valid human-readable information associated with the identification comprises at least one of an expiration date and a lot number associated with the container.

23. An apparatus for capturing human-readable text displayed on a container, said apparatus comprising:
means for capturing identification information associated with the container;
means for electronically capturing the human-readable text on the container; and
means for validating the human-readable text on the container against a known data set of valid values, linked to the identification information.

24. The apparatus of claim 23, wherein the human-readable text comprises at least one of an expiration date and a lot number associated with the container.

25. The apparatus of claim 23, wherein the means for electronically capturing the human-readable text comprises means for translating the human-readable text into machine-readable text using optical character recognition.

26. The apparatus of claim 23, wherein the means for electronically capturing the human-readable text further comprises means for translating the human-readable text on the container using neural network object detection to limit an area on an image of the container processed with optical character recognition.

27. A non-transitory computer program product for capturing human-readable text displayed on a container, wherein the computer program product comprises at least one computer-readable storage medium having computer-readable program code portions stored therein, the computer-readable program code portions comprising:
a first executive portion for identifying areas of interest on an image of the container;
a second executable portion for directing the capture of identification information associated with the container;
a third executable portion for directing the electronic capture of the human-readable text; and
a fourth executable portion for validating the human-readable text, wherein the container identification information is used to reference a database of valid human-readable values for the container.

28. The computer program product of claim 27, wherein the third executable portion is configured to translate the human-readable text into machine-readable text using optical character recognition.
